(19) United States
(12) Patent Application Publication
(10) Pub. No.: US 2026/0277416 A1
(43) Pub. Date: Sep. 17, 2026

(54) IMAGE DISPLAY APPARATUS, METHOD, AND PROGRAM

(71) Applicant: FUJIFILM Corporation, Tokyo (JP)

(72) Inventor: Koki FURUKAWA, Tokyo (JP)

(73) Assignee: FUJIFILM Corporation, Tokyo (JP)

(21) Appl. No.: 19/553,412

(22) Filed: Mar. 1, 2026

(30) Foreign Application Priority Data
Mar. 11, 2025 (JP) 2025-038412

(51) Int. Cl. G06F 3/04845; G06F 3/041; G06F 3/0486; G06F 3/04886

(52) U.S. Cl. CPC G06F 3/04845; G06F 3/0416; G06F 3/0486; G06F 3/04886

(57) ABSTRACT

A processor is configured to: display at least one medical image on a touch-type display screen; receive a touch operation by a user on the medical image; derive an auxiliary image including a touch position at which the touch operation is performed in the medical image from the medical image; and display the auxiliary image at a position different from the touch position on the display screen.

### CROSS REFERENCE TO RELATED APPLICATIONS

The present application claims priority from Japanese Patent Application No. 2025-038412, filed on Mar. 11, 2025, the entire disclosure of which is incorporated herein by reference.

### BACKGROUND

### TECHNICAL FIELD

The present disclosure relates to an image display apparatus, method, and program.

### RELATED ART

Image diagnosis is performed using a medical three-dimensional image captured by an imaging apparatus such as a computed tomography (CT) apparatus and a magnetic resonance imaging (MRI) apparatus. In a case of performing image diagnosis, a structure such as a lesion included in the medical image is measured. Various methods for measuring such a structure have been proposed. For example, a method has been proposed in which a medical image to be measured is displayed, a pointer that is a start point and an end point of measurement is generated by a touch operation on the medical image, the pointer is superimposed and displayed on the medical image, and an enlarged image on which the pointer is superimposed is generated and displayed as an auxiliary image (see JP2017-086561A). In the method described in JP2017-086561A, a position at which the auxiliary image is displayed so as not to overlap the measurement target is determined by analyzing the medical image.

However, in the method described in JP2017-086561A, in a case where the structure of the measurement target is complicated, the auxiliary image cannot be displayed at an appropriate position.

### SUMMARY OF THE INVENTION

The present disclosure has been made in view of the above circumstances, and an object thereof is to display the auxiliary image at an appropriate position regardless of a structure of a measurement target.

An image display apparatus according to the present disclosure comprises a processor,

in which the processor is configured to:

display at least one medical image on a touch-type display screen;

receive a touch operation by a user on the medical image;

derive an auxiliary image including a touch position at which the touch operation is performed in the medical image from the medical image; and

display the auxiliary image at a position different from the touch position on the display screen.

In the image display apparatus according to the present disclosure, the processor may be configured to display, on the auxiliary image, a measurement object for measuring a structure included in the medical image.

In the image display apparatus according to the present disclosure, the processor may be configured to derive the auxiliary image including the touch position in the medical image at a center.

In the image display apparatus according to the present disclosure, the processor may be configured to determine a display position of the auxiliary image depending on the touch position in the medical image.

In the image display apparatus according to the present disclosure, the processor may be configured to: determine whether the touch position is on a left side or a right side or on an upper side or a lower side of the display screen; and

determine a side opposite to the touch position on the display screen as the display position.

In the image display apparatus according to the present disclosure, the processor may be configured to determine a position opposite to a hand of the user performing the touch operation on the display screen as the display position.

In the image display apparatus according to the present disclosure, the processor is configured to:

display a plurality of the medical images on the display screen; and

display the auxiliary image on a medical image different from the medical image on which the touch operation is performed.

In the image display apparatus according to the present disclosure, the processor may be configured to enlarge and display the auxiliary image at a predetermined magnification.

In the image display apparatus according to the present disclosure, the processor may be configured to enlarge and display the auxiliary image according to a size of a structure included in the medical image at the touch position.

In the image display apparatus according to the present disclosure, the processor may be configured to:

receive a first touch operation;

determine a start point of measurement by receiving a drag-and-drop operation after the first touch operation;

receive a second touch operation; and

determine an end point of measurement by receiving a drag-and-drop operation after the second touch operation.

In the image display apparatus according to the present disclosure, the processor may be configured to enlarge and display the auxiliary image by a predetermined operation on the auxiliary image.

An image display method according to the present disclosure performed by a computer, the method comprises:

displaying at least one medical image on a touch-type display screen;

receiving a touch operation by a user on the medical image;

deriving an auxiliary image including a touch position at which the touch operation is performed in the medical image from the medical image; and

displaying the auxiliary image at a position different from the touch position on the display screen.

An image display program according to the present disclosure causes a computer to execute:

a process of displaying at least one medical image on a touch-type display screen;

a process of receiving a touch operation by a user on the medical image;

a process of deriving an auxiliary image including a touch position at which the touch operation is performed in the medical image from the medical image; and

a process of displaying the auxiliary image at a position different from the touch position on the display screen.

It should be noted that the technology of the present disclosure may be applied to a program product.

According to the present disclosure, the auxiliary image can be displayed at an appropriate position regardless of a structure of a measurement target.

### BRIEF DESCRIPTION OF THE DRAWINGS

FIG. 1 is a diagram showing a schematic configuration of an image display system to which an image display apparatus according to an embodiment of the present disclosure is applied.

FIG. 2 is a diagram showing a hardware configuration of the image display apparatus according to the present embodiment.

FIG. 3 is a functional configuration diagram of the image display apparatus according to the present embodiment.

FIG. 4 is a diagram showing a medical image displayed on a touch panel display.

FIG. 5 is a diagram showing a medical image displayed on the touch panel display.

FIG. 6 is a diagram showing an auxiliary image.

FIG. 7 is a diagram showing the auxiliary image.

FIG. 8 is a diagram for describing measurement using a measurement object displayed on the auxiliary image.

FIG. 9 is a diagram for describing measurement using a measurement object displayed on the auxiliary image.

FIG. 10 is a diagram for describing another example of the measurement using the measurement object displayed on the auxiliary image.

FIG. 11 is a diagram for describing another example of the measurement using the measurement object displayed on the auxiliary image.

FIG. 12 is a flowchart illustrating a process performed in the present embodiment.

FIG. 13 is a diagram showing a state in which a plurality of medical images are displayed.

FIG. 14 is a diagram showing a display position of the auxiliary image in a case where the plurality of medical images are displayed.

FIG. 15 is a diagram showing a display screen on which the auxiliary image is displayed on a side opposite to a hand that performs an operation.

FIG. 16 is a diagram showing a display screen on which the auxiliary image is displayed in an enlarged manner.

### DETAILED DESCRIPTION

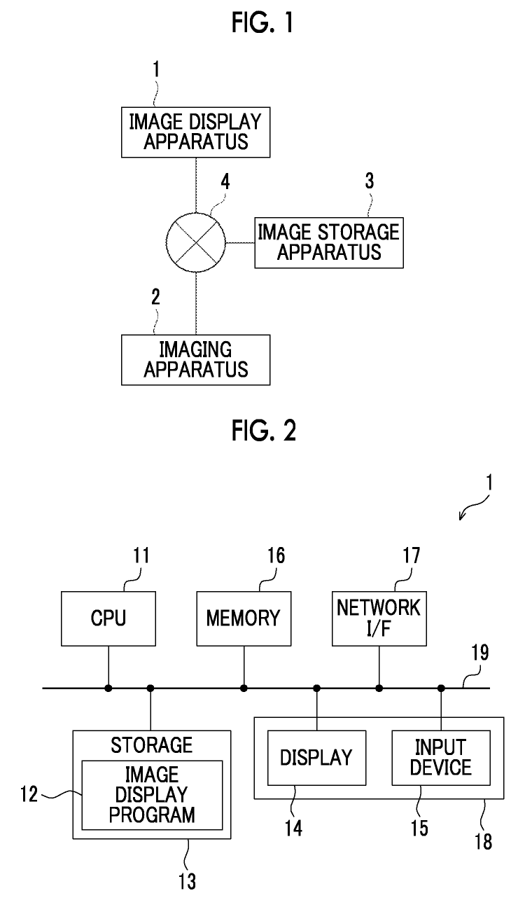

Hereinafter, description regarding embodiments of the present disclosure will be made with reference to the drawings. First, a configuration of an image display system to which the image display apparatus according to the present embodiment is applied will be described. FIG. 1 is a diagram showing a schematic configuration of an image display system. In the image display system shown in FIG. 1, an image display apparatus 1, an imaging apparatus 2, and an image storage apparatus 3 according to the present embodiment are connected to each other in a communicable state via a wired or wireless network 4. The network 4 is, for example, a network, such as a local area network (LAN) and a wide area network (WAN).

The imaging apparatus 2 is an apparatus that generates a two-dimensional image or a three-dimensional image representing a part of a subject to be diagnosed by imaging the part, and is specifically a radiography apparatus, a computed tomography (CT) apparatus, a magnetic resonance imaging (MRI) apparatus, a positron emission tomography (PET) apparatus, or the like. The medical image generated by the imaging apparatus 2 is transmitted to and stored in the image storage apparatus 3.

The image storage apparatus 3 is a computer that stores and manages the medical image, and comprises a storage device in which the medical image is stored. The image storage apparatus 3 transmits and receives the medical image generated by the imaging apparatus 2 to and from the image display apparatus 1 and the imaging apparatus 2 via the network 4. A storage format of the medical image and communication between the apparatuses via the network 4 are based on a predetermined protocol such as digital imaging and communication in medicine (DICOM).

Next, the image display apparatus according to the present embodiment will be described. Examples of the image display apparatus 1 include a portable terminal apparatus such as a tablet terminal and a smartphone. In the present embodiment, as an example, a case where the image display apparatus is a smartphone will be described.

FIG. 2 is a diagram showing a hardware configuration of the image display apparatus according to the present embodiment. As shown in FIG. 2, the image display apparatus 1 includes a central processing unit (CPU) 11, a memory 16 as a temporary storage area, and a nonvolatile storage unit 13. In addition, the image display apparatus 1 includes a display 14 such as a liquid crystal display or an organic electro-luminescence (EL) display, and an input device 15 such as a keyboard. In the present embodiment, the display 14 and the input device 15 are integrated as a touch panel display 18. In addition, the image display apparatus 1 includes a network interface (I/F) 17 connected to the network 4. The CPU 11, the memory 16, the storage unit 13, the touch panel display 18, and the network I/F 17 are connected to a bus 19.

The storage unit 13 is implemented using a hard disk drive (HDD), a solid state drive (SSD), a flash memory, or the like. An image display program 12 is stored in the storage unit 13 as a storage medium. The CPU 11 reads out the image display program 12 from the storage unit 13, loads the image display program 12 into the memory 16, and executes the loaded image display program 12.

The image display program 12 is stored in a storage device of a server computer connected to the network or a network storage in a state in which it can be accessed from the outside and is downloaded and installed in the image display apparatus 1 as required.

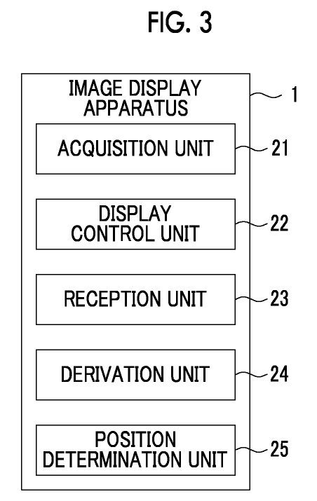

Next, a functional configuration of the image display apparatus according to the present embodiment will be described. FIG. 3 is a diagram showing a functional configuration of the image display apparatus according to the present embodiment. As shown in FIG. 3, the image display apparatus 1 comprises an acquisition unit 21, a display control unit 22, a reception unit 23, a derivation unit 24, and a position determination unit 25. Then, the CPU 11 executes the image display program 12, whereby the CPU 11 functions as the acquisition unit 21, the display control unit 22, the reception unit 23, the derivation unit 24, and the position determination unit 25.

The acquisition unit 21 acquires the medical image from the imaging apparatus 2 and/or the image storage apparatus 3. In the present embodiment, as the medical image to be acquired, for example, a CT image or an MRI image including a plurality of tomographic images is acquired, but the present disclosure is not limited thereto.

The display control unit 22 controls display of an image and an object on the touch panel display 18 in the present embodiment, such as display of a designated tomographic image on the touch panel display 18 from a plurality of tomographic images included in the medical image, display of an auxiliary image described below, and display of a measurement object. The touch panel display 18 is an example of a touch-type display screen according to the present disclosure, and is a display panel that can receive a touch operation, that is, an operation by touch.

The reception unit 23 specifies an operation performed by the user on the touch panel display 18. Specifically, the reception unit 23 specifies a content of the touch operation, that is, the touch operation performed by the user on the touch panel display 18, such as a tap, a drag, a drop, a double tap, a swipe, a pinch-out, and a pinch-in. The reception unit 23 receives various types of selection, instruction, and the like input by the user via the touch panel display 18 based on the specified content of the touch operation. The touch operation is performed by a touch pen or the like in addition to a finger.

In particular, in the present embodiment, the reception unit 23 receives designation of a start point and an end point of measurement of a structure by the user in order to measure the structure included in the medical image displayed on the touch panel display 18.

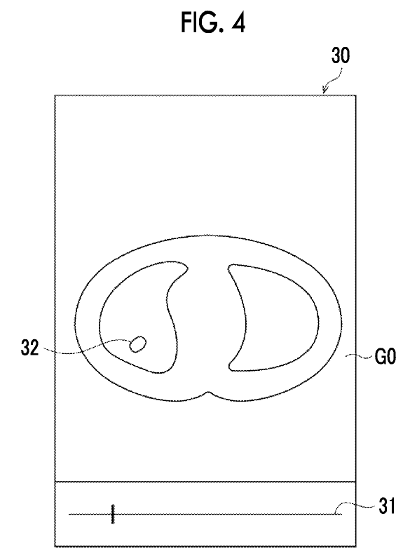

The derivation unit 24 derives the auxiliary image from the medical image. Hereinafter, derivation of the auxiliary image will be described. FIG. 4 is a diagram showing the medical image displayed on the touch panel display 18. As shown in FIG. 4, a medical image G0 and a slider 31 for switching a tomographic plane of the medical image G0 to be displayed are displayed on a display screen 30 of the touch panel display 18. The user can switch the tomographic plane of the medical image G0 displayed on the display screen 30 by moving the slider 31 left and right. The medical image G0 displayed in FIG. 4 includes a structure 32 that is considered to be a lesion.

In a case where the user measures the lesion, an operation of touching a start point of measurement in the lesion with a finger or the like, moving the finger in a measurement direction while maintaining the touched state, and releasing the finger or the like at an end point, that is, a drag-and-drop operation is performed. In a case where the reception unit 23 receives the touch operation on the medical image G0 by the user, the derivation unit 24 derives the auxiliary image including the touch position at which the touch operation is performed from the medical image G0.

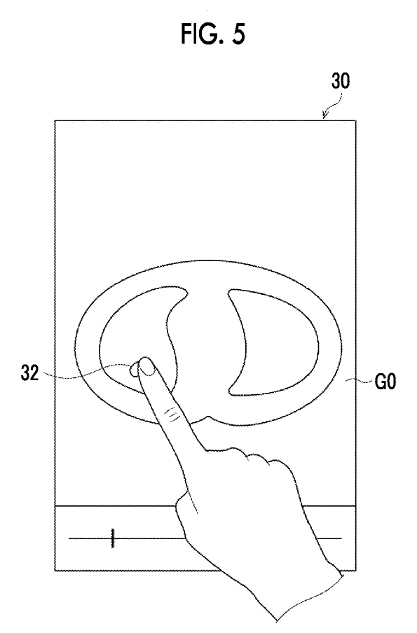

For example, as shown in FIG. 5, in a case where the user touches a vicinity of the lesion 32, the derivation unit 24 extracts a rectangular region of a predetermined range centered on the touch position from the medical image G0. In the present embodiment, the derivation unit 24 extracts, for example, a square region from the medical image G0. Then, the extracted region is enlarged by a predetermined magnification to derive an auxiliary image S0. A size of the auxiliary image S0 may be set to, for example, not exceed 1/2 of a width of the display screen 30 in a horizontal direction.

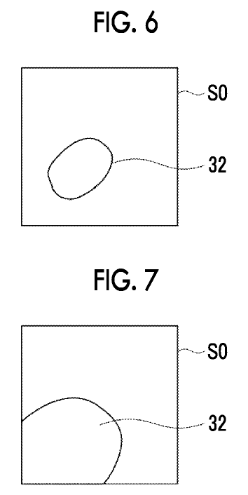

FIG. 6 is a diagram showing the derived auxiliary image. The predetermined magnification may be a magnification set in advance by the user or a default magnification set by the image display program 12. The predetermined magnification may be 1 (that is, not enlarged). The derivation unit 24 may detect the structure in the predetermined range including the touch position, and set the predetermined magnification according to a size of the detected structure. For example, as shown in FIG. 7, the predetermined magnification may be set such that the lesion 32 is largely included in the auxiliary image S0. In FIGS. 6 and 7, a right upper end portion of the lesion 32 is located substantially at the center of the auxiliary image S0. Therefore, the touch position on the medical image G0 by the user is in the vicinity of the right upper end portion of the lesion 32.

The position determination unit 25 determines a display position of the auxiliary image S0 derived by the derivation unit 24 on the display screen 30. Specifically, the position determination unit 25 determines the display position of the auxiliary image S0 at a position different from the touch position of the user on the display screen 30. In the present embodiment, the position determination unit 25 determines whether the touch position of the user is on a left side or a right side of the display screen 30 and whether the touch position of the user is on an upper side or a lower side of the display screen 30. The left side may be a left half of the display screen 30, and the right side may be a right half of the display screen 30. The upper side may be an upper half of the display screen 30, and the lower side may be a lower half of the display screen 30.

Then, the position determination unit 25 determines the display position of the auxiliary image S0 according to the determination result. For example, in a case where the touch position of the user is on the left side of the display screen 30, the position determination unit 25 determines the display position of the auxiliary image S0 on the right side opposite to the touch position on the display screen 30. In addition, in a case where the touch position of the user is on the lower side of the display screen 30, the position determination unit 25 determines the display position of the auxiliary image S0 on the upper side opposite to the touch position on the display screen 30. As shown in FIG. 5, in a case where the touch position of the user is on a lower left side of the display screen 30, the position determination unit 25 determines the display position of the auxiliary image S0 on an upper right side opposite to the touch position on the display screen 30.

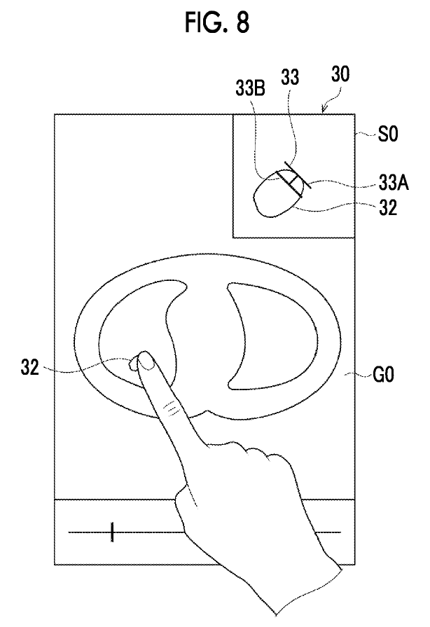

The display control unit 22 displays the auxiliary image S0 at the display position determined by the position determination unit 25. That is, the display control unit 22 displays the auxiliary image S0 at a position different from the touch position of the user on the display screen 30. FIG. 8 is a diagram showing a display screen on which the auxiliary image S0 is displayed. In FIG. 8, since the touch position of the user is on the lower left side of the display screen 30, the auxiliary image S0 is displayed on the upper right side of the display screen 30.

In the present embodiment, the display control unit 22 displays a measurement object for measurement on the auxiliary image S0. In FIG. 8, a measurement object 33 is displayed on the auxiliary image S0. In FIG. 8, the touch position of the user is the right upper end portion of the lesion 32. Therefore, in the auxiliary image S0, the right upper end portion of the lesion 32 is at a center position. In this case, since the center position of the auxiliary image S0 is the start point of measurement, a first end portion 33A of the measurement object 33 is displayed at the center position of the auxiliary image S0.

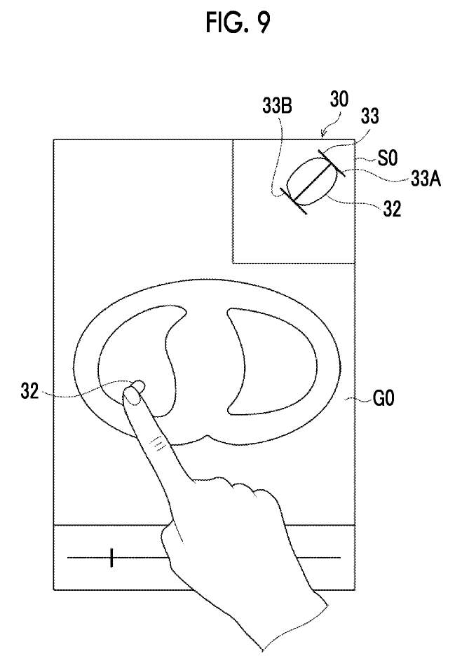

The user drags the measurement object 33 by sliding the finger to the end point of measurement of the lesion 32 while maintaining the touched state. As a result, the second end portion 33B of the measurement object 33 is moved to the end point, and as shown in FIG. 9, the first end portion 33A and the second end portion 33B of the measurement object 33 are positioned between the right upper end portion and the left lower end portion of the lesion 32 in the auxiliary image S0. In FIG. 9, the left lower end portion of the lesion 32 is moved to the center position of the auxiliary image S0 in response to the drag operation of the finger.

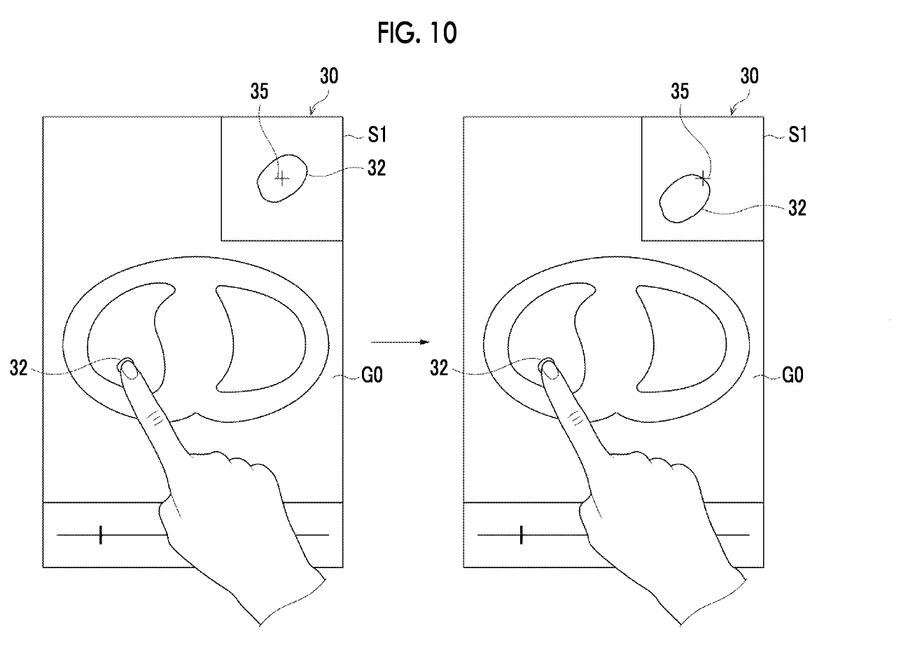

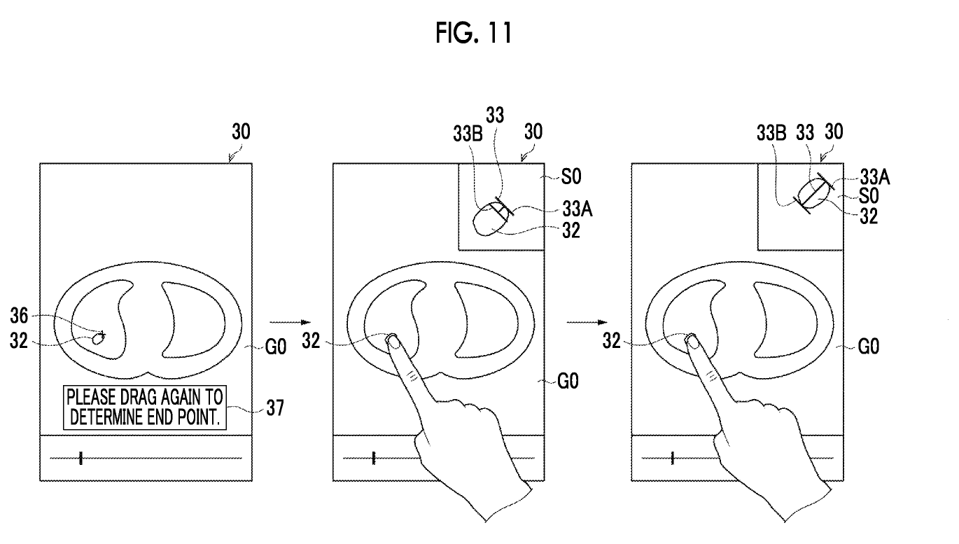

In a small touch panel display 18 such as that of a smartphone, it is difficult to accurately touch a start point and an end point of measurement with one touch operation. Hereinafter, a method for solving this problem will be described. FIGS. 10 and 11 are diagrams for describing another method for setting the start point of measurement. As shown on the left side of the display screen 30 in FIG. 10, the user touches a vicinity of the lesion 32 on the display screen 30 in order to set the start point of measurement of the lesion 32. As a result, the auxiliary image S0 is displayed on the display screen 30. In the auxiliary image S0, a cross-shaped cursor 35 is displayed at the touch position. A shape of the cursor 35 is not limited to the cross shape, and may be another shape such as a circular shape.

As shown on the right side of the display screen 30 in FIG. 10, the user drags and drops the cursor 35 while viewing the auxiliary image S0 to move the cursor 35 to the start point of measurement of the lesion 32. In this state, in a case where the user releases the finger from the touch panel display 18, as shown on the left side of the display screen 30 in FIG. 11, a cross-shaped cursor 36 is displayed at the start point of measurement of the lesion 32 in the medical image G0. The auxiliary image S0 is not displayed. In addition, a text 37 of "Please drag again to determine the end point" is displayed below the medical image G0.

As shown in the center display screen 30 in FIG. 11, the user touches a vicinity of the lesion 32 on the display screen 30 in order to set the end point of measurement of the lesion 32. As a result, the auxiliary image S0 is displayed on the display screen 30. In the auxiliary image S0, the measurement object 33 is displayed at a position of the start point that has already been set.

The user drags the measurement object 33 by sliding the finger to the end point of measurement of the lesion 32 while maintaining the touched state. As a result, the second end portion 33B of the measurement object 33 is moved to the end point, and as shown on the right side of the display screen 30 in FIG. 11, the first end portion 33A and the second end portion 33B of the measurement object 33 are positioned between the right upper end portion and the left lower end portion of the lesion 32 in the auxiliary image S0. As shown in FIGS. 10 and 11, by determining the start point and the end point of measurement, it is possible to perform the measurement more easily.

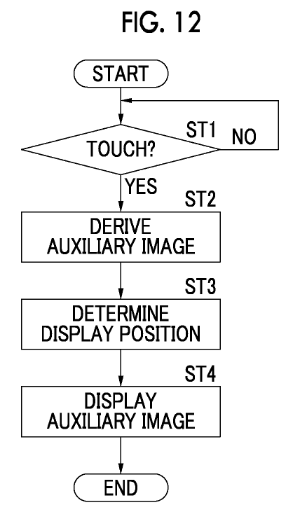

Hereinafter, a process performed in the present embodiment will be described. FIG. 12 is a flowchart illustrating the process performed in the present embodiment. It is assumed that the medical image G0 to be displayed is acquired by the acquisition unit 21 and stored in the storage unit 13, and the medical image G0 of the tomographic plane desired by the user is displayed on the touch panel display 18. The reception unit 23 monitors the user touching the touch panel display 18 for measurement or the like (step ST1), and in a case where the determination result in step ST1 is "Yes", the derivation unit 24 derives the auxiliary image S0 from the medical image G0 (step ST2).

Next, the position determination unit 25 determines the display position of the auxiliary image S0 on the display screen 30 (step ST3). The display control unit 22 displays the auxiliary image S0 at the determined display position (step ST4), and the process ends.

As described above, in the present embodiment, the auxiliary image S0 including the touch position is derived from the medical image G0, and the auxiliary image S0 is displayed at a position different from the touch position on the display screen 30. Therefore, the auxiliary image S0 can be displayed at an appropriate position that is easy for the user to see, regardless of the structure included in the medical image G0.

In addition, by deriving the auxiliary image S0 with the touch position as the center, it is possible to easily understand a relationship between the touch position and the structure included in the auxiliary image S0.

In addition, by determining the display position of the auxiliary image S0 depending on the touch position, the auxiliary image S0 can be displayed without being disturbed by the finger or the like of the user that touches the touch panel display 18.

In addition, by displaying the auxiliary image S0 in an enlarged manner according to the size of the structure included in the medical image G0 at the touch position, the structure can be easily seen in the auxiliary image S0.

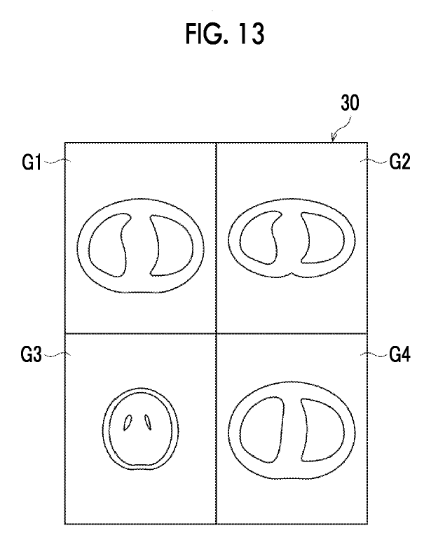

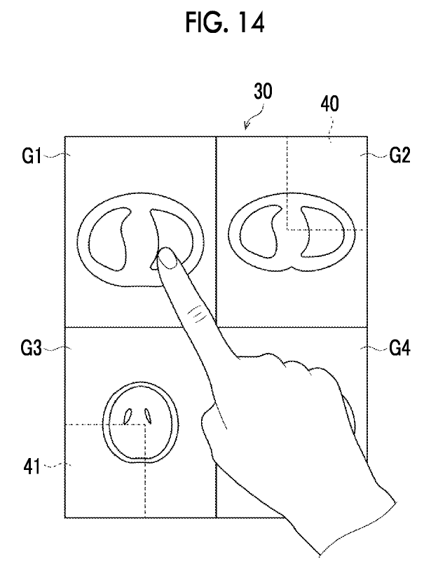

In the above-described embodiment, one medical image G0 is displayed on the touch panel display 18, but the present disclosure is not limited thereto. As shown in FIG. 13, the display screen 30 of the touch panel display 18 may be divided (in FIG. 13, divided into four parts) into a plurality of regions, and medical images G1 to G4 of different tomographic planes may be displayed in the divided regions. In this case, for example, as shown in FIG. 14, in a case where the user touches the medical image G1 displayed at the upper left of the display screen 30, the position determination unit 25 may determine a right upper region 40 or a left lower region 41 of the display screen 30 as the display position of the auxiliary image S0. In this case, the right upper region 40 overlaps the medical image G2, and the left lower region 41 overlaps the medical image G3, but the medical image G1 at the upper left is the medical image that the user is paying attention to. Therefore, even in a case where the auxiliary image S0 is displayed at a position overlapping the medical image G2 or the medical image G3, the observation of the medical image G1 by the user is not hindered.

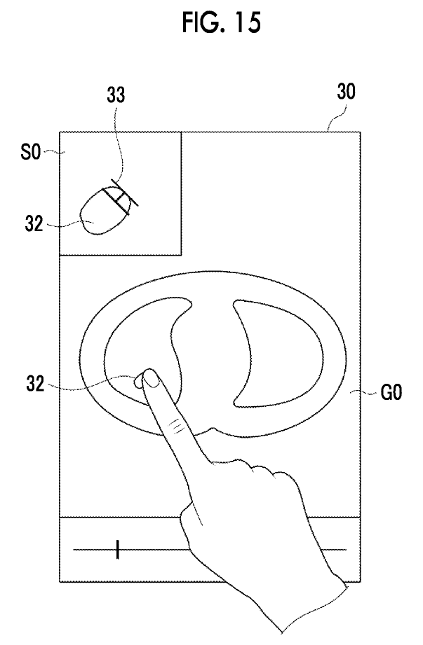

In addition, in the above-described embodiment, the auxiliary image S0 may be displayed on a side opposite to a hand of the user that operates the touch panel display 18. For example, in a case where the user operates with the right hand, as shown in FIG. 15, the auxiliary image S0 may be displayed on the left side of the display screen 30. In this case, the hand of the user that operates may be detected by a camera (not shown) included in the image display apparatus 1. In addition, since the user often operates with a dominant hand, the dominant hand of the user may be registered in advance in the image display apparatus 1, and the auxiliary image S0 may be displayed on a side opposite to the dominant hand of the user. As a result, it is possible to prevent the auxiliary image S0 from being difficult to see due to the hand that operates.

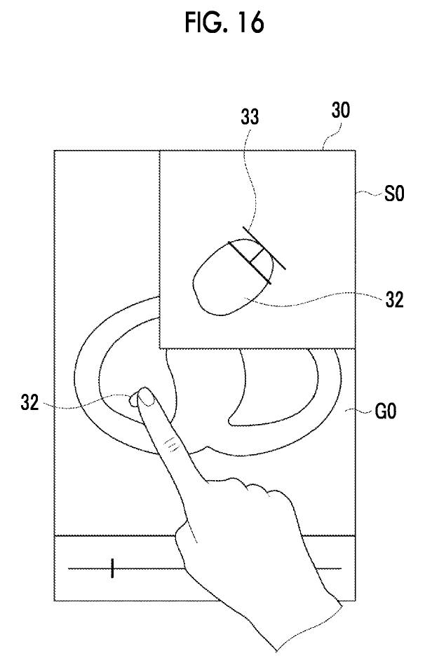

In addition, in the above-described embodiment, the auxiliary image S0 may be enlarged by a predetermined operation in a state in which the auxiliary image S0 is displayed. For example, as shown in FIG. 16, the auxiliary image S0 may be enlarged and displayed by continuing the touch operation on the medical image G0 with the right hand and touching the auxiliary image S0 with the left hand. As a result, the auxiliary image S0 can be seen more easily.

In the present embodiment, each process is executed by any computer. In addition, any computer may execute these types of processing by a processor as hardware, a program as software, or a combination thereof. In such a case, the processor may be configured to execute various types of processing according to the present embodiment in cooperation with the program, and can function as each unit or each means in the present embodiment. In addition, the execution order of the processing by the processor is not limited to the above-described order and may be changed as appropriate. Any computer may be a general-purpose computer, a computer for specific use, a workstation, or another system capable of executing each processing.

The processor may be configured using one or more pieces of hardware, and the type of hardware is not limited. For example, the processor may be configured using hardware, such as a central processing unit (CPU), a micro processing unit (MPU), a programmable logic device, such as a field programmable gate array (FPGA), a dedicated circuit that is used to execute specific processing, such as an application-specific integrated circuit (ASIC), a graphic processing unit (GPU), or a neural processing unit (NPU). In addition, the type of hardware may be a combination of different types of hardware. In a case where the plurality of types of hardware are configured to execute one or a plurality of types of processing of a certain processor, the plurality of types of hardware may exist in devices physically separated from each other or may exist in the same device. Additionally, in any of the embodiments, the order of each process by the processor is not limited to the order described above and may be changed as appropriate. The hardware is configured using an electrical circuit (circuitry) in which circuit elements, such as semiconductor elements, are combined, or the like.

The program may be software such as firmware or a microcode. In addition, the program may be, for example, a program module group, and each function thereof may be implemented by a processor configured to execute the corresponding function. The program may be a program code or a plurality of code segments stored in one or more non-transitory computer-readable media (for example, storage media, other storages, or the like). The program may be distributed and stored across a plurality of non-transitory computer-readable media that are present in devices physically separated from each other. The program code or the code segment may represent any combination of procedures, functions, subprograms, routines, subroutines, modules, software packages, classes, instructions, data structures, or program statements. The program code or the code segments may be connected to other code segments or hardware circuits by transmitting and receiving information, data, an argument, a parameter, or content of a memory.

In the above embodiment, the image display program 12 is described as being stored (installed) in the storage unit 13 in advance; however, the present disclosure is not limited thereto. The image display program 12 may be provided in a form recorded on a recording medium, such as a compact disc read-only memory (CD-ROM), a digital versatile disc read-only memory (DVD-ROM), and a universal serial bus (USB) memory. In addition, the image display program 12 may be provided in a form of a download from an external device via a network.

The technology of the present disclosure extends to all kinds of program products. The program product includes all forms of products for providing a program. For example, the program product includes a program provided through a network such as the Internet, a non-transitory computer-readable recording medium, such as a CD-ROM, a DVD, and a USB memory in which the program is stored, and the like.

The supplementary notes of the present disclosure will be described below.

### Supplementary Note 1

An image display apparatus comprising:

a processor,

wherein the processor is configured to:

display at least one medical image on a touch-type display screen;

receive a touch operation by a user on the medical image;

derive an auxiliary image including a touch position at which the touch operation is performed in the medical image from the medical image; and

display the auxiliary image at a position different from the touch position on the display screen.

### Supplementary Note 2

The image display apparatus according to Supplementary Note 1,

wherein the processor is configured to display, on the auxiliary image, a measurement object for measuring a structure included in the medical image.

### Supplementary Note 3

The image display apparatus according to Supplementary Note 1 or 2,

wherein the processor is configured to derive the auxiliary image including the touch position in the medical image at a center.

### Supplementary Note 4

The image display apparatus according to any one of Supplementary Notes 1 to 3,

wherein the processor is configured to determine a display position of the auxiliary image depending on the touch position in the medical image.

### Supplementary Note 5

The image display apparatus according to Supplementary Note 4,

wherein the processor is configured to:

determine whether the touch position is on a left side or a right side or on an upper side or a lower side of the display screen; and

determine a side opposite to the touch position on the display screen as the display position.

### Supplementary Note 6

The image display apparatus according to Supplementary Note 4,

wherein the processor is configured to determine a position opposite to a hand of the user performing the touch operation on the display screen as the display position.

### Supplementary Note 7

The image display apparatus according to any one of Supplementary Notes 1 to 6,

wherein the processor is configured to:

display a plurality of the medical images on the display screen; and

display the auxiliary image on a medical image different from the medical image on which the touch operation is performed.

### Supplementary Note 8

The image display apparatus according to any one of Supplementary Notes 1 to 7,

wherein the processor is configured to enlarge and display the auxiliary image at a predetermined magnification.

### Supplementary Note 9

The image display apparatus according to any one of Supplementary Notes 1 to 7,

wherein the processor is configured to enlarge and display the auxiliary image according to a size of a structure included in the medical image at the touch position.

### Supplementary Note 10

The image display apparatus according to any one of Supplementary Notes 1 to 9,

wherein the processor is configured to:

receive a first touch operation;

determine a start point of measurement by receiving a drag-and-drop operation after the first touch operation;

receive a second touch operation; and

determine an end point of measurement by receiving a drag-and-drop operation after the second touch operation.

### Supplementary Note 11

The image display apparatus according to any one of Supplementary Notes 1 to 10,

wherein the processor is configured to enlarge and display the auxiliary image by a predetermined operation on the auxiliary image.

### Supplementary Note 12

An image display method performed by a computer, the method comprising:

displaying at least one medical image on a touch-type display screen;

receiving a touch operation by a user on the medical image;

deriving an auxiliary image including a touch position at which the touch operation is performed in the medical image from the medical image; and

displaying the auxiliary image at a position different from the touch position on the display screen.

### Supplementary Note 13

An image display program causing a computer to execute:

a process of displaying at least one medical image on a touch-type display screen;

a process of receiving a touch operation by a user on the medical image;

a process of deriving an auxiliary image including a touch position at which the touch operation is performed in the medical image from the medical image; and

a process of displaying the auxiliary image at a position different from the touch position on the display screen.

What is claimed is:

1. An image display apparatus comprising:
a processor,
wherein the processor is configured to:
display at least one medical image on a touch-type display screen;
receive a touch operation by a user on the medical image;
derive an auxiliary image including a touch position at which the touch operation is performed in the medical image from the medical image; and
display the auxiliary image at a position different from the touch position on the display screen.

2. The image display apparatus according to claim 1,
wherein the processor is configured to display, on the auxiliary image, a measurement object for measuring a structure included in the medical image.

3. The image display apparatus according to claim 1,
wherein the processor is configured to derive the auxiliary image including the touch position in the medical image at a center.

4. The image display apparatus according to claim 1,
wherein the processor is configured to determine a display position of the auxiliary image according to the touch position in the medical image.

5. The image display apparatus according to claim 4,
wherein the processor is configured to:
determine whether the touch position is on a left side or a right side or on an upper side or a lower side of the display screen; and
determine a side opposite to the touch position on the display screen as the display position.

6. The image display apparatus according to claim 4,
wherein the processor is configured to determine a position opposite to a hand of the user performing the touch operation on the display screen as the display position.

7. The image display apparatus according to claim 1,
wherein the processor is configured to:
display a plurality of the medical images on the display screen; and
display the auxiliary image on a medical image different from the medical image on which the touch operation is performed.

8. The image display apparatus according to claim 1,
wherein the processor is configured to enlarge and display the auxiliary image at a predetermined magnification.

9. The image display apparatus according to claim 1,
wherein the processor is configured to enlarge and display the auxiliary image according to a size of a structure included in the medical image at the touch position.

10. The image display apparatus according to claim 1,
wherein the processor is configured to:
receive a first touch operation;
determine a start point of measurement by receiving a drag-and-drop operation after the first touch operation;
receive a second touch operation; and
determine an end point of measurement by receiving a drag-and-drop operation after the second touch operation.

11. The image display apparatus according to claim 1,
wherein the processor is configured to enlarge and display the auxiliary image by a predetermined operation on the auxiliary image.

12. An image display method performed by a computer, the method comprising:
displaying at least one medical image on a touch-type display screen;
receiving a touch operation by a user on the medical image;
deriving an auxiliary image including a touch position at which the touch operation is performed in the medical image from the medical image; and
displaying the auxiliary image at a position different from the touch position on the display screen.

13. A non-transitory computer-readable storage medium that stores an image display program causing a computer to execute:
a process of displaying at least one medical image on a touch-type display screen;
a process of receiving a touch operation by a user on the medical image;
a process of deriving an auxiliary image including a touch position at which the touch operation is performed in the medical image from the medical image; and
a process of displaying the auxiliary image at a position different from the touch position on the display screen.
